(19) United States
(12) Patent Application Publication
(10) Pub. No.: US 2024/0338003 A1
(43) Pub. Date: Oct. 10, 2024

(54) METHOD AND APPARATUS FOR PROCESSING DATA ASSOCIATED WITH AN ELECTRICAL MACHINE

(71) Applicant: Dunkermotoren GmbH, Bonndorf (DE)

(72) Inventors: Lucas Mülhaupt, Klettgau (DE); Michael Burgert, Kirchzarten (DE); Markus Weishaar, Bonndorf (DE)

(21) Appl. No.: 18/624,896

(22) Filed: Apr. 2, 2024

(30) Foreign Application Priority Data
Apr. 5, 2023 (DE) 102023108792.4

(51) Int. Cl. G05B 19/042

(52) U.S. Cl. CPC G05B 19/0426; G05B 2219/25174

(57) ABSTRACT

A method, for example a computer-implemented method, for processing data associated with at least one electrical machine, for example an electric motor. The method includes providing a first function for communicating with a first electrical machine via a machine interface, providing a second function for communicating with at least one further electrical machine via a communication interface, wherein the communication interface is different from the machine interface.

### CROSS REFERENCE TO RELATED APPLICATIONS

The present application claims priority under 35 U.S.C. § 119 (a) to German National Patent Application No. 10 2023 108792.4 filed on Apr. 5, 2023, which is expressly incorporated by reference herein.

### FIELD

The present disclosure relates generally to a system and method for processing data associated with an electrical machine, and more particularly to a processing system and method for processing data associated with an electric motor.

### BACKGROUND

The statements in this section provide a description of related art and are not admissions of prior art. No admission is made that the related art is publicly available or known to others besides the inventors.

An improved system and method is needed for communicating with and controlling a plurality of electrical machines, such as motors, and processing data for a plurality of electrical machines.

### SUMMARY

The following presents a summary of the disclosed subject matter in order to present some aspects of the disclosed subject matter.

The disclosure relates to a method for processing data associated with an electrical machine.

The disclosure further relates to an apparatus for processing data associated with an electrical machine.

Exemplary embodiments relate to a method, for example a computer-implemented method, for processing data associated with at least one electrical machine, for example an electric motor, comprising: providing a first function for communicating with a first electrical machine via a machine interface, providing a second function for communicating with at least one further electrical machine via a communication interface, wherein the communication interface is different from the machine interface. In further exemplary embodiments, this enables efficient and flexible communication with the first electrical machine and/or with the at least one further electrical machine.

In further exemplary embodiments, the machine interface is designed, for example, as a local interface or interface with a comparatively short spatial range (e.g. less than 100 m (meters), for example less than 10 m, for example less than 1 m).

In further exemplary embodiments, the machine interface is, for example, configured for data communication (e.g. transmitting and/or receiving information, for example data) between an apparatus performing at least some aspects according to exemplary embodiments and the first electrical machine, for example exactly one electrical machine, or a comparatively small number of electrical machines within the range of the machine interface.

In further exemplary embodiments, the communication interface is associated, for example, with a communication system, for example a network, for example of the Ethernet type, for example of the Industrial Ethernet type, and enables data communication, for example over comparatively large distances, for example greater than 10 m or greater than 100 m or more.

In further exemplary embodiments, the communication interface enables data communication with several other units, e.g. other electrical machines and/or units of other types, such as data processing devices (e.g. computers, e.g. personal computers), Internet-of-Things (IoT) devices, for example Industrial IoT (IIoT) devices, public networks (e.g., Internet), (virtual) private networks (e.g., a company network or a network of a manufacturing facility), cloud systems or cloud servers, edge servers, etc.

In further exemplary embodiments, it is provided that the method comprises at least one of the following elements: a) providing the first function by means of a library, b) providing the second function by means of a or the library. For example, the library is designed as a program or function library, for example as a dynamically bindable or embeddable library.

In further exemplary embodiments, the first function may be provided, for example, by means of a first library, and the second function may be provided, for example, by means of a second library that is different from the first library.

In further exemplary embodiments, the first function and the second function can be provided by means of the same library.

In further exemplary embodiments, it is provided that the method comprises at least one of the following elements: a) receiving first information via the machine interface from the first electrical machine, b) transmitting second information via the machine interface to the first electrical machine, c) receiving third information via the communication interface from the at least one further electrical machine, d) transmitting fourth information via the communication interface to the at least one further electrical machine, e) processing at least a part of the first information, f) processing at least a part of the third information.

In further exemplary embodiments, for example, at least a part of the second information and/or at least a part of the fourth information may be formed based at least in part on the first information and/or the third information.

In further exemplary embodiments, it is provided that the method comprises: receiving the first information via the machine interface from the first electrical machine, processing at least a part of the first information, wherein processed first information is obtained, transmitting the fourth information based at least on the processed first information via the communication interface to the at least one further electrical machine.

In further exemplary embodiments, it is provided that the method comprises: receiving the third information via the communication interface from the at least one further electrical machine, processing at least a part of the third information, wherein processed third information is obtained, transmitting the second information based at least on the processed third information via the machine interface to the first electrical machine.

In further exemplary embodiments, it is provided that the method comprises: executing at least a first sub-function associated with an application, for example a distributed application, which controls at least some aspects of an interaction of a plurality of electrical machines, wherein, for example, at least a second sub-function associated with the application is executable by at least one further unit associated with the at least one further electrical machine.

In further exemplary embodiments, it is provided that the method comprises at least one of the following elements: a) at least temporarily assuming a client role, for example for at least temporarily controlling the first electrical machine by another unit, for example at least one further electrical machine or an apparatus associated with the at least one further electrical machine, b) at least temporarily assuming a server role or master role, for example for controlling one or more electrical machines.

In further exemplary embodiments, it is provided that the method comprises at least one of the following elements: a) at least temporarily controlling, for example regulating, an operation of the at least one further electrical machine, for example via the communication interface, for example in the sense of a or the distributed application, b) at least temporarily controlling, for example regulating, an operation of the first electrical machine, for example via the machine interface, for example in the sense of a or the distributed application.

In further exemplary embodiments, it is provided that the method comprises at least one of the following elements: a) executing a first computer program in a resource area, for example memory area, managed for example by means of a memory protection device, wherein for example the first computer program is associated with a or the first sub-function of a or the, for example distributed, application, b) exchanging information by means of the first computer program with the first electrical machine via the machine interface, c) exchanging information by means of the first computer program with the at least one further electrical machine via the communication interface.

In further exemplary embodiments, it is provided that the method comprises at least one of the following elements: a) providing a first computing device for executing at least one computer program for controlling at least the first electrical machine, for example via the machine interface, and, optionally, executing the at least one computer program for controlling at least the first electrical machine by means of the first computing device, b) providing a or the first computer program associated with a or the first sub-function of a or the, for example distributed, application for controlling at least the first electrical machine and, optionally, executing the first computer program by means of the first computing device, c) providing a computer program for controlling the communication interface, and, optionally, executing the computer program for controlling the communication interface by means of the first computing device, d) providing a second computing device, which is different from the first computing device, for controlling the communication interface, e) providing a computer program for controlling the communication interface, and, optionally, executing the computer program for controlling the communication interface by means of the second computing device.

In further exemplary embodiments, it is provided that the method comprises: providing a computer program for controlling a system comprising a plurality of electrical machines, and, optionally, executing the computer program for controlling the system by means of the first computing device and/or the second computing device.

In further exemplary embodiments, it is provided that executing the computer program for controlling the system comprises at least one of the following elements: a) exchanging information with one or the first electrical machine via the machine interface, b) exchanging information with at least one further electrical machine of the plurality of electrical machines via the communication interface.

In further exemplary embodiments, it is provided that the communication interface is an Ethernet interface, for example industrial Ethernet interface.

Further exemplary embodiments relate to an apparatus for carrying out the method according to the embodiments.

Further exemplary embodiments relate to an apparatus according to the embodiments, comprising at least one of the following elements: a) the machine interface, b) the communication interface, c) a or the first computing device, d) a or the second computing device.

Further exemplary embodiments relate to an electrical machine, for example an electric motor, for example a rotary electric motor or linear motor, comprising at least one apparatus according to the embodiments.

Further exemplary embodiments relate to a computer-readable storage medium comprising instructions which, when executed by a computer, cause the computer to perform the method according to the embodiments.

Further exemplary embodiments relate to a computer program comprising instructions which, when the program is executed by a computer, cause the computer to execute the method according to the embodiments.

Further exemplary embodiments relate to a data carrier signal that transmits and/or characterizes the computer program according to the embodiments.

Further exemplary embodiments relate to a use of the method according to the embodiments and/or the apparatus according to the embodiments and/or the electrical machine according to the embodiments and/or the computer-readable storage medium according to the embodiments and/or the computer program according to the embodiments and/or the data carrier signal according to the embodiments for at least one of the following elements: a) controlling and/or regulating operation of at least one electrical machine, b) enabling a, for example, free and/or deterministic, for example horizontal, communication from a first electrical machine or an apparatus associated with the first electrical machine to at least one further electrical machine or at least one apparatus associated with the further electrical machine, c) use of an Ethernet communication system, for example a network, to implement distributed applications associated with at least one electrical machine, d) decentralized implementation of applications for controlling and/or regulating which use at least one electrical machine, e) avoiding a, for example dedicated, master role for data exchange with respect to at least one electrical machine, f) providing a plurality of communication channels, for example via a same bus medium of a communication system, for example network, wherein, for example, a first communication channel can be used for controlling and/or regulating at least one electrical machine, and wherein, for example, a second communication channel can be used for aspects of the Internet-of-Things (IoT), for example Industrial IoT (IIoT), g) increasing reliability, h) providing and/or operating a network of electrical machines.

### BRIEF DESCRIPTION OF THE DRAWINGS

The present disclosure may be better understood, and its numerous features and advantages made apparent to those skilled in the art, by referencing the accompanying drawings. The use of the same reference symbols in different drawings may indicate similar, equivalent, or identical components or a different embodiment of a component. Further features, possible applications and advantages of the invention are apparent from the following description of embodiments of the invention, which are shown in the figures of the drawing. All the features described or illustrated form the object of the invention, either individually or in any combination, irrespective of their summarization in the claims or their relationship to one another and irrespective of their formulation or illustration in the description or in the drawing.

FIG. 1 schematically illustrates a simplified flow diagram according to exemplary embodiments.

FIG. 2 schematically illustrates a simplified block diagram according to exemplary embodiments.

FIG. 3 schematically illustrates a simplified flow diagram according to exemplary embodiments.

FIG. 4 schematically illustrates a simplified flow diagram according to exemplary embodiments.

FIG. 5 schematically illustrates a simplified flow diagram according to exemplary embodiments.

FIG. 6 schematically illustrates a simplified flow diagram according to exemplary embodiments.

FIG. 7 schematically illustrates a simplified block diagram according to exemplary embodiments.

FIG. 8 schematically illustrates a simplified flow diagram according to exemplary embodiments.

FIG. 9 schematically illustrates a simplified flow diagram according to exemplary embodiments.

FIG. 10 schematically illustrates a simplified flow diagram according to exemplary embodiments.

FIG. 11 schematically illustrates a simplified block diagram according to exemplary embodiments.

FIG. 12 schematically illustrates a simplified flow diagram according to exemplary embodiments.

FIG. 13 schematically illustrates a simplified flow diagram according to exemplary embodiments.

FIG. 14 schematically illustrates a simplified block diagram according to exemplary embodiments.

FIG. 15 schematically illustrates a simplified block diagram according to exemplary embodiments.

FIG. 16 schematically illustrates aspects of uses according to exemplary embodiments.

### DETAILED DESCRIPTION

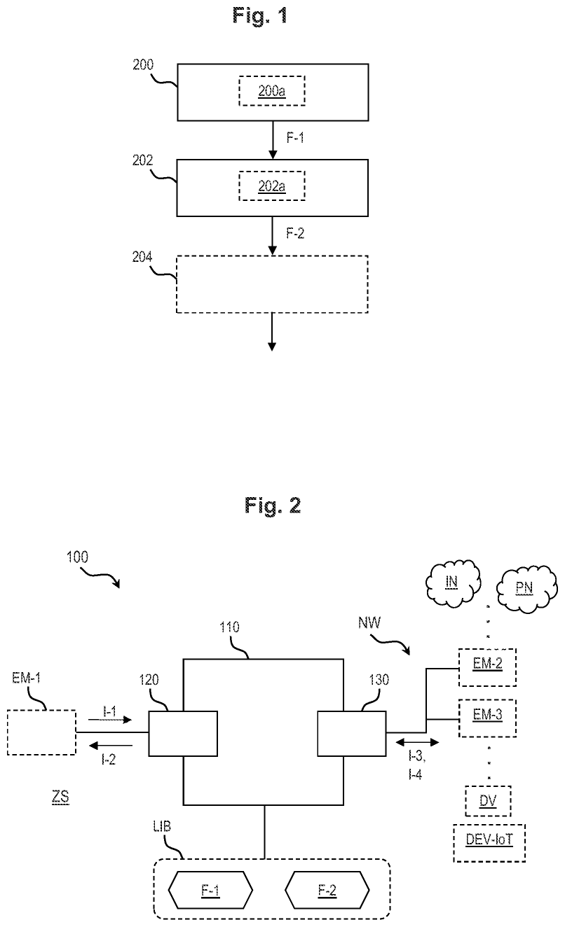

Exemplary embodiments, cf. FIGS. 1, 2, relate to a method, for example a computer-implemented method, for processing data associated with at least one electrical machine EM-1 (FIG. 2), for example an electric motor, comprising: providing 200 (FIG. 1) a first function F-1 for communicating with a first electrical machine EM-1 via a machine interface 120, providing 202 a second function F-2 for communicating with at least one further electrical machine EM-2, EM-3 via a communication interface 130, wherein communication interface 130 is different from machine interface 120. In further exemplary embodiments, this enables efficient and flexible communication of an apparatus 100 executing the method with the first electrical machine EM-1 and/or with the at least one further electrical machine EM-2, EM-3, etc.

In further exemplary embodiments, FIG. 2, apparatus 100 may comprise, for example, at least one computing device 110, e.g. for performing at least some aspects according to exemplary embodiments.

In further exemplary embodiments, FIG. 2, machine interface 120 is designed, for example, as a local interface or interface with a comparatively short spatial range (e.g. less than 100 m (meters), for example less than 10 m, for example less than 1 m). In other words, for example, apparatus 100 or computing device 110 is arranged comparatively close to the first electrical machine EM-1, for example attached to or built into the first electrical machine EM-1 or to a target system ZS (e.g. automation technology device) accommodating the first electrical machine EM-1.

In further exemplary embodiments, FIG. 2, machine interface 120 is, for example, configured for data communication (e.g. transmitting and/or receiving information I-1, I-2, for example data) between a or apparatus 100 performing at least some aspects according to exemplary embodiments and the first electrical machine EM-1, for example exactly one electrical machine, or a comparatively small number of electrical machines (not shown) within the range of machine interface 120.

In further exemplary embodiments, FIG. 2, communication interface 130 is associated, for example, with a communication system, for example network NW, for example of the Ethernet type, for example Industrial Ethernet type, and enables data communication, for example over comparatively large distances, for example greater than 10 m or greater than 100 m or more.

In further exemplary embodiments, FIG. 2, communication interface 130 enables data communication with a plurality of other units, e.g. other electrical machines EM-2, EM-3, . . . and/or units of other types such as data processing devices DV (e.g. computers, e.g. personal computers), IoT or IIoT devices DEV-IoT, public networks (e.g. Internet) IN, (virtual) private networks PN (e.g. company network or network of a production facility), cloud systems or cloud servers, edge servers, etc.

In further exemplary embodiments, FIG. 1, it is provided that the method comprises at least one of the following elements: a) providing 200a the first function F-1 by means of a library LIB (FIG. 2), b) providing 202a the second function F-2 by means of a or the library LIB. For example, the library LIB is designed as a program or function library, for example as a statically or dynamically bindable or embeddable library.

In further exemplary embodiments, the first function F-1 may be provided, for example, by means of a first library LIB, and the second function F-2 may be provided, for example, by means of a second library (not shown) that is different from the first library LIB.

In further exemplary embodiments, FIG. 2, the first function F-1 and the second function F-2 can be provided by means of the same library LIB.

In further exemplary embodiments, see the optional block 204 according to FIG. 1, the first function F-1 and the second function F-2 may be used for a flexible exchange (e.g. transmitting and/or receiving) of information I-1, I-2, I-3, I-4, for example data, for an operation of at least one component 100, 110, 120, 130, EM-1, EM-2, EM-3, NW, DV, DEV-IoT, PN, IN, ZS, . . . EM-2, EM-3, . . . , transmitting 213 fourth information I-4 via communication interface 130 to the at least one further electrical machine EM-2, EM-3, . . . , processing 214 at least a part of the first information I-1, processing 215 at least a part of the third information I-3.

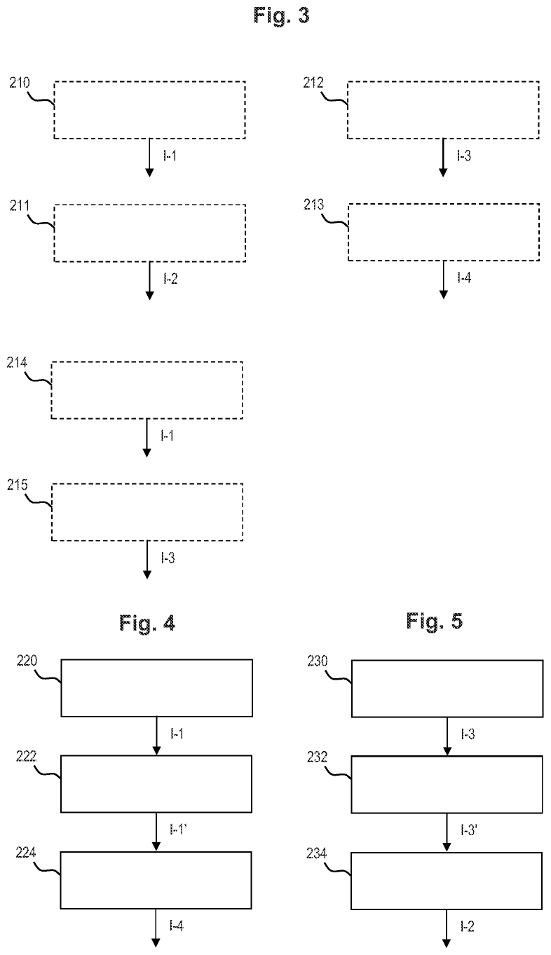

In further exemplary embodiments, FIG. 3, it is provided that the method comprises at least one of the following elements: a) receiving 210 first information I-1 via machine interface 120 (FIG. 2) from the first electrical machine EM-1, b) transmitting 211 (FIG. 3) second information I-2 via machine interface 120 to the first electrical machine EM-1, c) receiving 212 third information I-3 via communication interface 130 from the at least one further electrical machine EM-2, EM-3, . . . , d) transmitting 213 fourth information I-4 via communication interface 130 to the at least one further electrical machine EM-2, EM-3, . . . , e) processing 214 at least a part of the first information I-1, f) processing 215 at least a part of the third information I-3.

In further exemplary embodiments, for example, at least a part of the second information I-2 and/or at least a part of the fourth information I-4 may be formed based at least in part on the first information I-1 and/or the third information I-3.

In further exemplary embodiments, FIG. 4, it is provided that the method comprises: receiving 220 the first information I-1 via machine interface 120 (FIG. 2) from the first electrical machine EM-1, processing at least a part of the first information I-1, whereby processed first information I-1′ is obtained, transmitting 224 the fourth information I-4 based at least on the processed first information I-1′ via communication interface 130 (FIG. 3) to the at least one further electrical machine EM-2, EM-3, . . . and/or to at least one of the other units or devices DV, DEV-IoT, PN, IN, NW.

In further exemplary embodiments, FIG. 5, it is provided that the method comprises: receiving 230 the third information I-3 via communication interface 130 (FIG. 2) from the at least one further electrical machine EM-2, EM-3, . . . , processing 232 at least a part of the third information I-3, wherein processed third information I-3′ is obtained, transmitting 234 the second information I-2 based at least on the processed third information I-3′ via machine interface 120 (FIG. 2) to the first electrical machine EM-1.

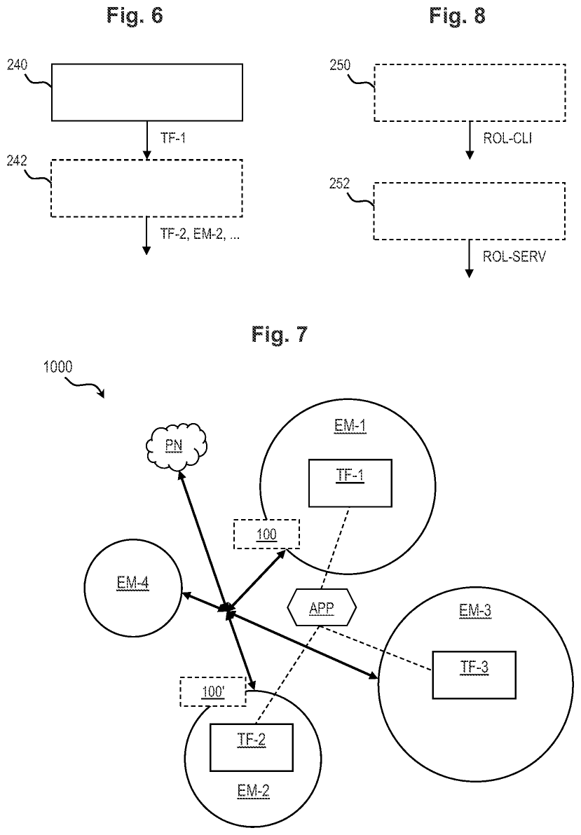

In further exemplary embodiments, FIGS. 6, 7, it is provided that the method comprises: executing 240 at least a first sub-function TF-1 associated with an application APP, for example a distributed application (FIG. 7), which controls at least some aspects of an interaction of a plurality of electrical machines EM-1, EM-2, EM-3, EM-4, wherein, for example, at least a second sub-function TF-2 associated with the application APP is executable by at least one further unit 100′ (FIG. 7) associated with the at least one further electrical machine EM-2, see the optional block 242 according to FIG. 6.

In this way, for example, the application APP can be executed in parallel or in a decentralized manner by a system 1000 comprising a plurality of electrical machines EM-1, EM-2, EM-3, EM-4, for example by different electrical machines EM-1, EM-2, EM-3, . . . or their associated apparatuses 100, 100′, . . . execute respective sub-functions TF-1, TF-2, TF-3, . . . of the application APP. A corresponding data exchange between the components involved, and optionally a private network PN, for example, can be realized by means of an Ethernet network NW (see also FIG. 2), which is symbolized in FIG. 7 by the double arrows not denoted.

In further exemplary embodiments, FIG. 8, it is provided that the method comprises at least one of the following elements: a) at least temporarily assuming 250 a client role ROL-CLI, for example by apparatus 100 (FIG. 2) and/or by computing device 110 or the associated electrical machine EM-1, for example for at least temporarily controlling the first electrical machine EM-1 by another unit, for example at least one further electrical machine EM-2 or an apparatus 100′ associated with the at least one further electrical machine (FIG. 7), b) at least temporarily assuming 252 (FIG. 7) a server role ROL-SERV, for example by apparatus 100 (FIG. 2) and/or by computing device 110 or the associated electrical machine EM-1, for example for controlling one or more (e.g. other) electrical machines EM-2, EM-3, EM-4.

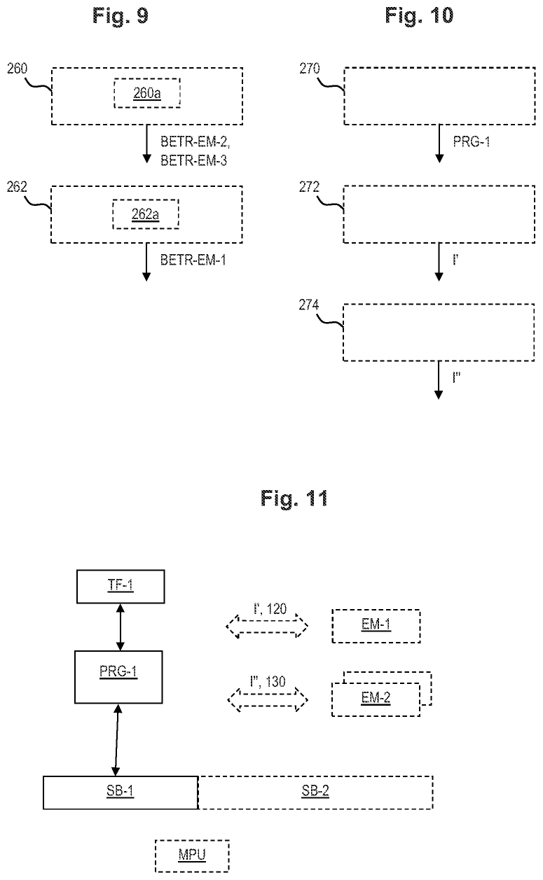

In further exemplary embodiments, FIG. 9, it is provided that the method has at least one of the following elements: a) at least intermittently controlling 260, for example regulating 260a, an operation BETR-EM-2, BETR-EM-3 of the at least one further electrical machine EM-2, EM-3, for example via communication interface 130, for example in the sense of a or the distributed application APP, b) at least temporarily controlling 262, for example regulating 262a, an operation BETR-EM-1 of the first electrical machine EM-1, for example via machine interface 120, for example in the sense of a or the distributed application APP (FIG. 7). Information can be exchanged via machine interface 120, for example by means of the first function F-1 (FIG. 2). Information can be exchanged via communication interface 130, for example by means of the second function F-2 (FIG. 2).

In further exemplary embodiments, FIGS. 10, 11, it is provided that the method comprises at least one of the following elements: a) executing 270 (FIG. 10) a first computer program PRG-1 in a resource area, for example memory area, SB-1, managed for example by means of a memory protection unit MPU (FIG. 11), wherein, for example, the first computer program PRG-1 is associated with a or the first sub-function TF-1 of a or the, for example distributed, application APP, b) exchanging 272 information I′ by means of the first computer program PRG-1 with the first electrical machine EM-1 via machine interface 120, for example by using the first function F-1 (FIG. 2), c) exchanging 274 information I″ by means of the first computer program PRG-1 with the at least one further electrical machine EM-2, . . . via communication interface 130, for example using the second function F-2 (FIG. 2).

FIG. 11 shows an example of a further memory area SB-2 in addition to the first memory area SB-1, which is also managed by the memory protection unit MPU, for example.

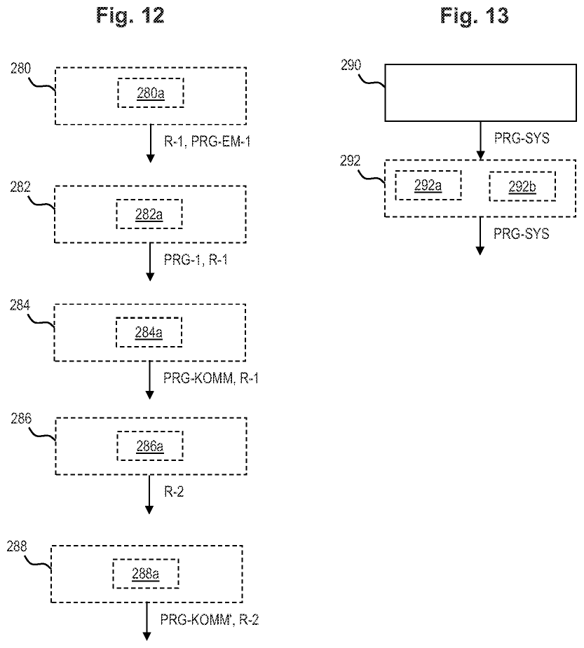

In further exemplary embodiments, FIG. 12, it is provided that the method comprises at least one of the following elements: providing 280 a first computing device R-1 for executing at least one computer program PRG-EM-1 for controlling at least the first electrical machine EM-1, for example via machine interface 120 (FIG. 2), and, optionally, executing 280a the at least one computer program PRG-EM-1 for controlling at least the first electrical machine EM-1 by means of the first computing device R-1, b) providing 282 a or the first computer program PRG-1 associated with a or the first sub-function TF-1 of a or the, for example distributed, application APP (FIG. 7) for controlling at least the first electrical machine EM-1 and, optionally, executing 282a the first computer program PRG-1 by means of the first computing device R-1, c) providing 284 a computer program PRG-KOMM for controlling communication interface 130, and, optionally, executing 284a the computer program PRG-KOMM for controlling communication interface 130 by means of the first computing device R-1, d) providing 286 a second computing device R-2, which is different from the first computing device R-1, for controlling 286a communication interface 130, e) providing 288 a computer program PRG-KOMM′ for controlling communication interface 130, and, optionally, executing 288a the computer program PRG-KOMM′ for controlling communication interface 130 by means of the second computing device R-2.

In further exemplary embodiments, FIG. 13, it is provided that the method comprises: providing 290 a computer program PRG-SYS for controlling a system 1000 (FIG. 7) comprising a plurality of electrical machines, and, optionally, executing 292 the computer program PRG-SYS for controlling the system 1000 by means of the first computing device R-1 and/or the second computing device R-2.

In further exemplary embodiments, FIG. 13, it is provided that the execution 292 of the computer program PRG-SYS for controlling the system 1000 comprises at least one of the following elements: a) information exchange 292a with a or the first electrical machine EM-1 via machine interface 120, for example using the first function F-1 (FIG. 2), b) information exchange 292b with at least one further electrical machine EM-2, EM-3, . . . of the plurality of electrical machines via communication interface 130, for example using the second function F-2 (FIG. 2).

In further exemplary embodiments, FIG. 2, it is provided that communication interface 130 is an Ethernet interface, for example an industrial Ethernet interface.

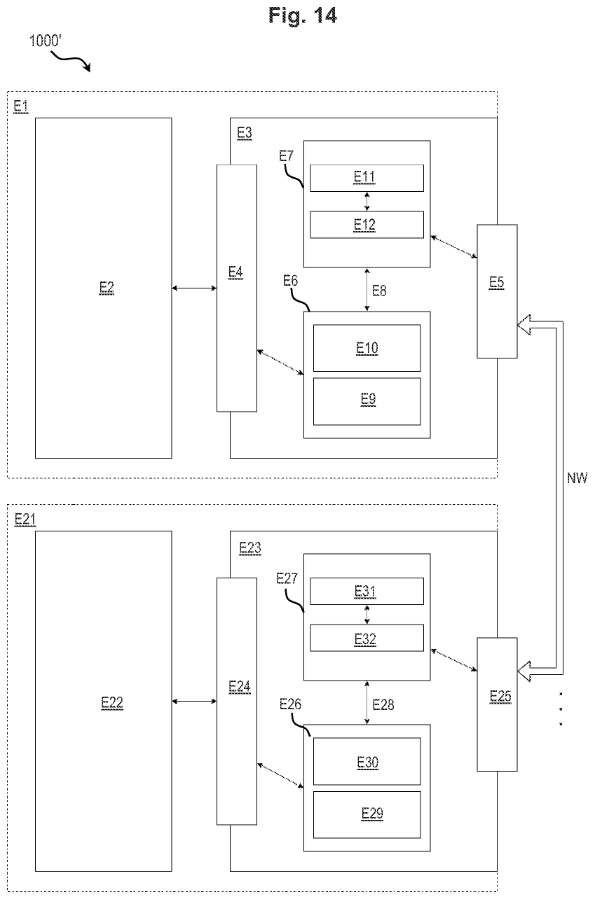

FIG. 14 schematically shows a simplified block diagram of a system 1000′ according to exemplary embodiments. Element E1 symbolizes a first drive, comprising a motor E2 and an electronic apparatus E3 for motor E2. In further exemplary embodiments, apparatus E3 may, for example, be identical or similar to apparatus 100 (FIG. 2).

In further exemplary embodiments, FIG. 14, apparatus E3 has an interface E4 which, for example, realizes at least some aspects of machine interface 120 according to FIG. 2.

In further exemplary embodiments, FIG. 14, apparatus E3 has a communication interface E5, e.g. similar to communication interface 130 according to FIG. 2.

In further exemplary embodiments, apparatus E3 has a first computing device E6 and a second computing device E7. Computing devices E6, E7 can exchange information via a, for example bidirectional, data connection E8, e.g. an interface of the Quad Serial Peripheral Interface (QSPI) type.

In further exemplary embodiments, the first computing device E6 is designed to execute at least one computer program E9 for controlling and/or regulating motor E2. The computer program E9 can be stored, for example, in a memory device not shown, which is assigned to the first computing device E6. As an example, computer program E9 can be provided by a manufacturer of drive E1 and is designed to control basic functions of motor E2.

In further exemplary embodiments, the first computing device E6 is designed to execute at least one computer program E10 which, for example, implements at least one sub-function TF-1 (FIG. 7) of a, for example distributed, application APP. Computer program E10 can also be stored, for example, in a memory device not shown, which is assigned to the first computing device E6. As an example, computer program E10 can be provided by a user of drive E1 and is designed, for example, to implement the aforementioned sub-function TF-1 of application APP. For this purpose, in further exemplary embodiments, computer program E10 can, for example, make use of the functionality of computer program E9.

In further exemplary embodiments, computer programs E9, E10 can be executed in different resource areas, e.g. memory areas, of the first computing device E6, which increases the security of an operation. In this way, for example, it can be ruled out that computer program E10 accesses memory areas of computer program E9, which could, for example, lead to impairment of the control and/or regulation of motor E2. A separation of memory areas E9, E10 can be realized in further exemplary embodiments, e.g. by a memory protection unit MPU (FIG. 7).

In further exemplary embodiments, the first computing device E6 is designed, for example, to control operation of machine interface E4.

In further exemplary embodiments, the second computing device E7 is designed, for example, to control the operation of communication interface E5. For example, a protocol stack E11 can be implemented using the second computing device E7, e.g. of the PROFINET type, with element E12 symbolizing a socket interface, for example.

In further exemplary embodiments, FIG. 14, apparatus E3 may use the first function F-1 (FIG. 2), for example, to communicate with motor E2 via machine interface E4.

In further exemplary embodiments, FIG. 14, apparatus E3 can use the second function F-2 (FIG. 2), e.g. for communication with further components E21, . . . via communication interface E5 and via network NW.

In further exemplary embodiments, instead of the two computing devices E6, E7, which may for example each be designed as a microcontroller, a single computing device (not shown in FIG. 14, see for example element 110 of FIG. 2) may also be provided, which realizes some or all aspects of the functions of computing devices E6, E7 described above by way of example.

Element E21 symbolizes a second drive, comprising a motor E22 and an electronic apparatus E23 for motor E22. In further exemplary embodiments, drive E21 is identical or similar to drive E1, wherein elements E22, E23, E24, E25, E26, E27, E28, E29, E30, E31, E32 of drive E21 correspond, for example, to elements E2, E3, E4, E5, E6, E7, E8, E9, E10, E11, E12 of drive E1.

In further exemplary embodiments, FIG. 14, system 1000′ can also have more than the two drives E1, E21 shown in the present example and can be used, for example, to execute distributed applications APP (FIG. 7), for example with regard to coordinated or synchronized operation of drives E1, E21 and possibly other components DV, DEV-IoT, . . . (FIG. 2), wherein, for example, at least one computing device E6, E26 can be operated at least temporarily as a client or as a server.

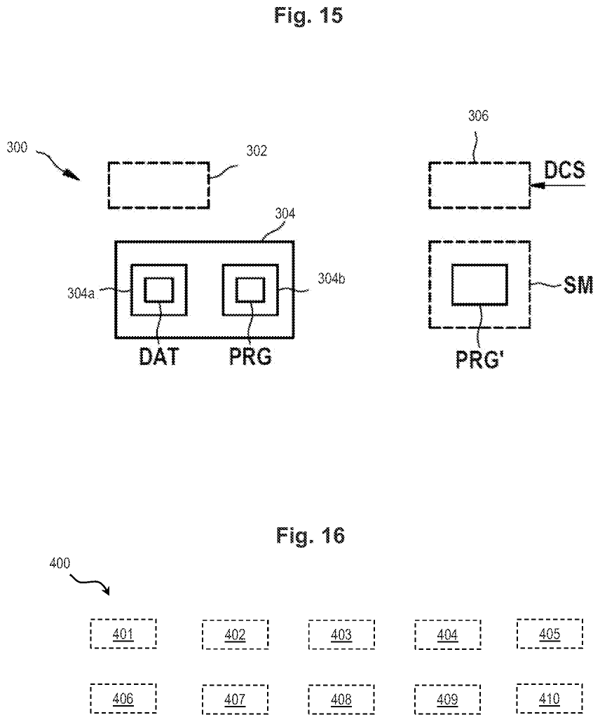

Further exemplary embodiments, FIG. 15, relate to an apparatus 300 for implementing at least some aspects of the method according to the embodiments. For example, apparatus 300 may be used to implement at least parts of apparatuses 100, 100′, E3, E6, E7, E23, E26, E27.

In further exemplary embodiments, FIG. 15, it is provided that apparatus 300 comprises: a computing device (“computer”) 302 comprising at least one computing core, a memory device 304 associated with computing device 302 for at least temporarily storing at least one of the following elements: a) data DAT, computer program(s) PRG, for example for executing the method according to the embodiments.

In further exemplary embodiments, data DAT comprises at least one of the following elements: a) data associated with application APP or the at least one sub-function TF-1, b) data associated with the first function F-1 (FIG. 2), c) data associated with the second function F-2 (FIG. 2), d) data associated with at least one electrical machine EM-1, EM-2, EM-3, . . . , e) data associated with machine interface 120, f) data associated with communication interface 130, g) data associated with library LIB.

In further exemplary embodiments, computer program(s) PRG may be, for example, at least one of the computer programs described above by way of example.

In further exemplary embodiments, FIG. 15, memory device 304 comprises a volatile memory (e.g. random access memory (RAM)) 304a, and/or a non-volatile (NVM) memory (e.g. flash EEPROM) 304b, or a combination thereof or with other memory types not explicitly mentioned. By way of example, at least one of the memory areas SB-1, SB-2 according to FIG. 11 can be realized by means of memory device 304.

Further exemplary embodiments, FIG. 15, relate to a computer-readable storage medium SM comprising instructions PRG′ which, when executed by a computer 302, cause computer 302 to perform the method according to the embodiments.

Further exemplary embodiments, FIG. 15, relate to a computer program PRG comprising instructions that, when program PRG is executed by a computer 302, cause computer 302 to perform the method according to the embodiments.

Further exemplary embodiments relate to a data carrier signal DCS characterizing and/or transmitting the computer program PRG, PRG′ according to the embodiments. Data carrier signal DCS is receivable, for example, via an optional data interface 306 of apparatus 300. Data DAT, for example, can also be transmitted (sent and/or received) via the optional data interface 306.

In further exemplary embodiments, data interface 306 implements machine interface 120 and/or communication interface 130.

Further exemplary aspects and embodiments are described below, each of which can be combined individually or in combination with at least one of the exemplary embodiments described above.

In further exemplary embodiments, the principle according to the embodiments enables, e.g. direct, e.g. free or deterministic horizontal communication, e.g. between electrical machines such as motors and/or between motor control units 100, 100′, e.g. via Ethernet, e.g. for exchanging information, for example control commands, for example in parallel with an industrial Ethernet or standalone.

In further exemplary embodiments, the principle according to the embodiments enables a vertical integration of electrical machines EM-1, EM-2, . . . , e.g. in company networks NP, e.g. for communication with various software and/or devices DEV, e.g. also via Ethernet.

In further exemplary embodiments, the principle according to the embodiments enables to dispense with a separate control, for example in the role of a master, whereby, for example, at least in some embodiments comparatively simple structures are made possible.

In further exemplary embodiments, a bandwidth of Ethernet also enables, for example, parallel communication paths, for example IIoT and a motor controller, to be handled on the same physical medium, e.g. the same line.

In further exemplary embodiments, the principle according to the embodiments enables decentralized and/or autonomous data exchange and/or synchronization, e.g. between individual motors EM-1, EM-2, . . . and/or motor control units 100, 100′, E3, E23, and/or e.g. mutual control between the motors/motor control units. In further exemplary embodiments, this also leads, for example, to increased reliability, since in the event of a component failure, for example, only parts of the system (e.g. a sub-function TF-1) and not the entire system would be affected.

In further exemplary embodiments, the principle according to the embodiments enables the provision of a standardized interface, e.g., in motors EM-1, EM-2, . . . and/or motor control units 100, 100′, via which these can be addressed, for example, by other motors/motor control units according to exemplary embodiments and/or by external programs and devices, e.g. for programming and/or analysis and/or communication.

In further exemplary embodiments, one or more mechanisms are provided for detection and/or declaration of motors EM-1, EM-2, . . . and/or motor controllers 100, 100′ located in network NW.

In further exemplary embodiments, the principle according to the embodiments enables the provision of a basis to be able to set up applications APP which, for example, enable deterministic mechanisms, e.g. to ensure synchronization.

In further exemplary embodiments, the principle according to the embodiments enables the provision of a basis to be able to set up applications APP that enable mechanisms for monitoring the communication.

In further exemplary embodiments, the principle according to the embodiments enables the provision of a basis for mechanisms to connect motors EM-1, EM-2, . . . to form a network 1000, 1000′ with equal rights, for example.

In further exemplary embodiments, the principle according to the embodiments enables the provision of mechanisms to operate motors EM-1, EM-2, . . . as a network NW, 1000, 1000′.

For example, in further exemplary embodiments, deterministic communication can be allowed between different motors EM-1, EM-2, . . . and/or motor control units 100, 100′, e.g. having equal rights, for example without the use of a dedicated master in the system, which enables, for example, the realization of high-performance control topologies without central control.

For example, in further exemplary embodiments, one or more protocols such as Industrial Ethernet and/or IIoT communication such as Open Platform Communications (OPC) protocol or OPC Unified Architecture (OPC UA) protocol may be used in parallel to the communication between electrical machines EM-1, EM-2, . . . according to the embodiments in the same physical network NW.

Further advantages and aspects are mentioned below, which can be achieved at least temporarily in at least some exemplary embodiments: Cost-effective system structure, simple system structure, structure of decentralized topologies, structure of modular topologies, comparatively high transmission rates, comparatively high flexibility, e.g. due to the possibility of parallel communication, efficient status monitoring of individual motors/motor control units, comparatively complex autonomous tasks of a motor network 1000, 1000′ possible, own protocol can be used, can be extended, e.g. for future functions and/or devices (e.g. HMI (human-machine interface)).

Further exemplary embodiments relate to an apparatus 100, 300 according to the embodiments, comprising at least one of the following elements: a) machine interface 120 (FIG. 2), b) communication interface 130, c) a or the first computing device R-1, E6, d) a or the second computing device R-2, E7.

Further exemplary embodiments relate to an electric machine EM-1, E2, for example electric motor, for example rotary electric motor or linear motor, comprising at least one apparatus 100, 300 according to the embodiments.

Further exemplary embodiments, FIG. 16, relate to a use 400 of the method according to the embodiments and/or the apparatus according to the embodiments and/or the electrical machine according to the embodiments and/or the computer-readable storage medium according to the embodiments and/or the computer program according to the embodiments and/or the data carrier signal according to the embodiments for at least one of the following elements: a) controlling 401 and/or regulating 402 an operation of at least one electrical machine, b) enabling 403 a communication, for example free and/or deterministic, for example horizontal, from a first electrical machine EM-1 or an apparatus associated with the first electrical machine to at least one further electrical machine EM-2 or at least one apparatus associated with the further electrical machine, c) using 404 an Ethernet communication system, for example a network, for implementing distributed applications associated with at least one electrical machine, d) decentralized implementation 405 of applications for controlling and/or regulating system using at least one electrical machine, e) avoiding 406 a master role, for example a dedicated master role, for an exchange of data relating to at least one electrical machine, f) providing 407 several communication channels, for example via a same bus medium of a communication system, for example network, wherein for example a first communication channel is usable for controlling and/or regulating at least one electrical machine, and wherein, for example, a second communication channel is usable for aspects of the Internet-of-Things (IoT) for example Industrial IoT (IIoT) g) increasing 408 a reliability, h) providing 409 and/or operating 410 a network of electrical machines.

1. A method for processing data associated with at least one electrical machine, comprising:
providing a first function for communicating with a first electrical machine via a machine interface;
providing a second function for communicating with at least one further electrical machine via a communication interface, wherein the communication interface is different from the machine interface.

2. The method according to claim 1, comprising at least one of the following elements:
(a) providing the first function by means of a library;
(b) providing the second function by means of a or the library.

3. The method according to claim 1, comprising at least one of the following elements:
(a) receiving first information via the machine interface from the first electrical machine; (b) transmitting second information via the machine interface to the first electrical machine;
(c) receiving third information via the communication interface from the at least one further electrical machine;
(d) transmitting fourth information via the communication interface to the at least one further electrical machine;
(e) processing at least a part of the first information;
(f) processing at least a part of the third information.

4. The method according to claim 3, comprising:
receiving the first information via the machine interface from the first electrical machine;
processing at least a part of the first information to obtain processed first information;
transmitting the fourth information based at least on the processed first information via the communication interface to the at least one further electrical machine.

5. The method according to claim 4, comprising:
receiving the third information via the communication interface from the at least one further electrical machine;
processing at least a part of the third information to obtain processed third information;
transmitting the second information based at least on the processed third information via the machine interface to the first electrical machine.

6. The method according to claim 5, comprising:
executing at least a first sub-function associated with an application, wherein the application may include a distributed application, wherein the at least first sub-function controls at least some aspects of an interaction of a plurality of electrical machines, wherein at least a second sub-function associated with the application is executable by at least one further unit associated with the at least one further electrical machine.

7. The method according to claim 6, comprising at least one of the following elements: a) at least temporarily assuming a client role; b) at least temporarily assuming a server role.

8. The method according to claim 7, comprising at least one of the following elements: a) at least temporarily controlling an operation of the at least one further electrical machine, via the communication interface, in the sense of a or the distributed application; b) at least temporarily controlling an operation of the first electrical machine via the communication interface in the sense of a or the distributed application.

9. The method according to claim 8, comprising:
(a) executing a first computer program in a resource area, including a memory area, managed by means of a memory protection unit, wherein the first computer program is associated with a or the first sub-function of a or the application;
(b) exchanging information by means of the first computer program with the first electrical machine via the machine interface;
(c) exchanging information by means of the first computer program with the at least one further electrical machine via the communication interface.

10. The method according to claim 9, comprising at least one of the following elements:
(a) providing a first computing device for executing at least one computer program for controlling at least the first electrical machine, via the machine interface, and/or executing the at least one computer program for controlling at least the first electrical machine by means of the first computing device;
(b) providing a or the first computer program associated with a or the first sub-function of a or the application for controlling at least the first electrical machine and/or executing the first computer program by means of the first computing device;
(c) providing a computer program for controlling the communication interface, and executing the computer program for controlling the communication interface by means of the first computing device;
(d) providing a second computing device, which is different from the first computing device, for controlling the communication interface;
(e) providing a computer program for controlling the communication interface and/or executing the computer program for controlling the communication interface by means of the second computing device.

11. The method according to claim 10, comprising: providing a computer program for controlling a system comprising a plurality of electrical machines and/or executing the computer program for controlling the system by means of the first computing means and/or the second computing means.

12. The method according to claim 11, wherein executing the computer program for controlling the system comprises at least one of the following elements:
(a) exchanging information with a or the first electrical machine via the machine interface;
(b) exchanging information with at least one further electrical machine of the plurality of electrical machines via the communication interface.

13. The method according to claim 12, wherein the communication interface is an Ethernet interface or an industrial Ethernet interface.

14. The method of claim 1, wherein the method comprises a computer-implemented method and wherein the electrical machine includes a motor.

15. An apparatus for carrying out the method according to claim 1.

16. The apparatus according to claim 15, comprising at least one of the following elements:
(a) the machine interface;
(b) the communication interface;
(c) a or the first computing device;
(d) a or the second computing device.

17. The apparatus according to claim 16, wherein the apparatus is incorporated into at least one of: an electric machine, an electric motor, a rotary electric motor, or a linear motor.

18. A computer readable storage medium comprising instructions which, when executed by a computer, cause the computer to perform the method according to claim 1.

19. A computer program stored on at least one computer readable storage medium comprising instructions which, when the computer program is executed by a computer, causes the computer to perform the method according to claim 1.

20. The method of claim 1, wherein the method includes at least one of the following elements:
(a) controlling and/or regulating the operation of the at least one electrical machine;
(b) enabling a free and/or deterministic and/or horizontal communication from the at least one electrical machine or an apparatus associated with the at least one first electrical machine to the at least one further electrical machine or at least one apparatus associated with the at least one further electrical machine;
(c) using an Ethernet communication system for realizing distributed applications associated with the at least one electrical machine;
(d) decentralized implementation of applications for controlling and/or regulating the at least one electrical machine;
(e) avoiding a dedicated, master role for data exchange with respect to the at least one electrical machine;
(f) providing a plurality of communication channels via a same bus medium of the Ethernet communication system, wherein a first communication channel is used for controlling and/or regulating the at least one electrical machine, and wherein a second communication channel is used for communication using Internet-of-Things (IoT) or Industrial IoT (IIoT) protocols;
(g) providing and/or operating a network of electrical machines (EM-1, EM-2, EM-3, . . . ).
